(19) United States
(12) Patent Application Publication
(10) Pub. No.: US 2012/0213062 A1
(43) Pub. Date: Aug. 23, 2012

(54) METHOD OF TWO-STAGE ADAPTIVE FREQUENCY HOPPING FOR CLUSTERED WIRELESS SENSOR NETWORK

(75) Inventors: Wei LIANG, Shenyang (CN); Haibin YU, Shenyang (CN); Xiaoling ZHANG, Shenyang (CN); Miao YANG, Shenyang (CN); Weijie XU, Shenyang (CN); Jun WANG, Shenyang (CN); Peng ZENG, Shenyang (CN)

(73) Assignee: Shenyang Institute of Automation of the Chinese Academy of Sciences, Shenyang (CN)

(21) Appl. No.: 13/455,118

(22) Filed: Apr. 24, 2012

Related U.S. Application Data
(63) Continuation-in-part of application No. PCT/CN2010/070121, filed on Jan. 11, 2010.

(30) Foreign Application Priority Data
Jan. 8, 2010 (CN) 201010010064.1

(51) Int. Cl. H04W 84/18; H04W 28/04; H04W 24/10

(52) U.S. Cl. 370/228; 370/255; 370/252

(57) ABSTRACT

A method of two-stage adaptive frequency hopping for a clustered wireless sensor network, including: a) building a clustered wireless sensor network; b) defining a superframe structure based on IEEE 802.15.4 according to a topology of the clustered wireless sensor network; c) extending a beacon frame payload based on a beacon frame format of an IEEE 802.15.4 Media Access Control (MAC) layer; and d) performing a two-stage adaptive frequency hopping mechanism on nodes based on the above superframe structure and the extended beacon frame of the IEEE 802.15.4 MAC layer.

### CROSS-REFERENCE TO RELATED APPLICATIONS

This application is a continuation-in-part of International Patent Application No. PCT/CN2010/070121 with an international filing date of Jan. 11, 2010, designating the United States, now pending, and further claims priority benefits to Chinese Patent Application No. 201010010064.1 filed Jan. 8, 2010. The contents of all of the aforementioned applications, including any intervening amendments thereto, are incorporated herein by reference.

### CORRESPONDENCE ADDRESS

Inquiries from the public to applicants or assignees concerning this document should be directed to: MATTHIAS SCHOLL P.C., ATTN.: DR. MATTHIAS SCHOLL ESQ., 14781 MEMORIAL DRIVE, SUITE 1319, HOUSTON, Tex. 77079.

### BACKGROUND OF THE INVENTION

1. Field of the Invention

The invention relates to a wireless communication technology, and more particularly to a method of two-stage adaptive frequency hopping for a clustered wireless sensor network.

2. Description of the Related Art

Since 21^{st} century, with the rapid development of disciplines, such as MEMS (Micro-Electro-Mechanism System), computer, communication, and automation control and artificial intelligence, a new type of monitoring and control networks—WSN (Wireless Sensor Network) comes into being.

WSN is an intelligent and autonomous monitoring and control network system, which consists of many ubiquitous tiny sensor nodes having communication and computing capabilities. These sensor nodes are densely planted in an unattended monitoring area and complete the assigned task according to the environment. WSN is a large scale, unattended, resource-limited distributed system and utilizes multi-hop peer communication, the network topology of which dynamically changes with self-organizing, autonomous, adaptive and other smart properties. If the Internet has changed the communication way among people, the WSN would merge the logical information world and the real physical world together, which will change the interaction way between people and nature. The emergence of WSNs has attracted worldwide attention.

In the aspect of network structure, WSNs have large scale. When the network size and convenience of the network management are taken into consideration, a cluster structure shall be the most common topology for WSNs. In the aspect of communication protocols, IEEE 802.15.4 has many features compared with existing wireless communication standards, such as low energy consumption, low cost, easy use, and high flexibility, which make it a most promising under layer communication protocol for WSNs. Therefore, the communication method of this invention is based on IEEE 802.15.4. In the aspect of network performance, many applications, such as industrial and military applications, have higher requirement of network reliability. To overcome the serious interference problem during the wireless transmission and improve the network reliability, WSNs typically utilize frequency hopping mechanisms or adaptive frequency hopping mechanisms. However, existing IEEE 802.15.4 standard has no function of frequency hopping. Moreover, the multi-level adaptive frequency hopping technology for clustered WSNs that are based on IEEE 802.15.4 has not been reported until now.

### SUMMARY OF THE INVENTION

To overcome the shortages that existing IEEE 802.15.4 standard has no function of frequency hopping and the multi-level adaptive frequency hopping technology for clustered WSNs that are based on IEEE 802.15.4 has not been reported until now, the technical problems for this invention to solve is to provide a method of two-stage adaptive frequency hopping for a clustered wireless sensor network to improve the system reliability.

To solve the above technical problems, the adopted technical scheme in this invention is described below.

The invention provides a method of two-stage adaptive frequency hopping for a clustered wireless sensor network, comprising the steps of:
Building a clustered wireless sensor network;
Defining a superframe structure based on IEEE 802.15.4 according to a topology of the clustered wireless sensor network;
Extending a beacon frame payload based on a beacon frame format of an IEEE 802.15.4 Media Access Control (MAC) layer; and
Performing a two-stage adaptive frequency hopping mechanism on nodes based on the above superframe structure and the extended beacon frame of the IEEE 802.15.4 MAC layer.

The clustered wireless sensor network comprises the following three kinds of nodes: a sink node, a cluster header node, and a cluster member node. The sink node is a data convergence center, which provides interfaces for clustered WSNs to connect with other WSNs and is used to manage node joining, network formation, and network performance monitoring; the cluster header node is used to duplicate and forward data in a clustered WSN, to transmit or forward data to cluster member nodes, sink node, and other cluster header nodes in the network, and to support any kinds of sensors and actuators; the cluster member node that is set up in industrial fields and connects with sensors and actuators is used for transmitting measurement and control data. The cluster header node and the cluster member node constitute clusters. The cluster member node communicates with only one cluster header node, but not with each other. The cluster header node communicates with the sink node and other cluster header nodes.

The superframe structure based on IEEE 802.15.4 comprises a beacon frame period, a contention access period (CAP), a contention-free period (CFP), an intra-cluster communication period, an inter-cluster communication period, and a sleeping period.

The beacon frame period is used for timeslot synchronization and superframe information publishing.

The contention access period (CAP) is used for node adding and intra-cluster management, which realizes medium access control by the timeslot Carrier Sense Multiple Access with Collision Avoidance (CSMA/CA) algorithm.

The contention-free period (CFP) is used for emergency communications and communications among mobile cluster member nodes and cluster header nodes, which is distributed by cluster header nodes themselves. In contention-free access period, communication is finished by using the Time Division Multiple Access (TDMA) mechanism.

The intra-cluster communication period is the extension of the CFP and used for intra-cluster communication.

The inter-cluster communication period is used for inter-cluster communication and management.

Both the intra-cluster communication period and the inter-cluster communication period use TDMA to finish communication.

The intra-cluster communication means communication between the cluster header node and the cluster member node; the inter-cluster means communication among the cluster header nodes and communication between the cluster header node and the sink node.

The two-stage adaptive frequency hopping comprises a period adaptive frequency hopping (PAFH) and a timeslot adaptive frequency hopping (TAFH).

Period adaptive frequency hopping (PAFH): in the superframe of a clustered WSN, the beacon period, contention access period, and contention-free access period use the same channel in the same superframe cycle, and change the channels according to the channel conditions in different superframe cycles. When the channel condition is bad, the communication channel is changed by the nodes. The channel condition is evaluated by Packet Loss Rate (PLR) and retransmission times.

Timeslot adaptive frequency hopping (TAFH): in the superframe of a clustered WSN, timeslots of intra-cluster communication period change the communication channel according to the channel condition; when the channel condition is bad; the node changes the communication channel condition. The channel condition is evaluated by PLR and retransmission times.

Before the two-stage adaptive frequency hopping, the channel condition is measured. The channel measurement is used for offering the channel condition to the sink node and the cluster header node, helping the sink node and the cluster header node to allocate communication channel. A cluster member node or a cluster header node can measure one or more channel condition, and report the statistical information to the cluster header node or the sink node. The cluster member node transmits the measurement result collected from cluster member nodes to cluster header nodes, and a cluster header node transmits the channel condition collected from itself and from the cluster member nodes to the sink node.

In the process of channel measurement, each node records the conditions of all the channels that are used for communication with the node in the measurement period; the recorded performance information comprises packet loss rate and retransmission times; The packet loss rate are determined by the number of the acknowledgment frames (ACK) and the number of transmitted packets.

The realization process of PAFH is as follows:
1) First, the sink node allocates channels for each cluster header node's beacon period, CAP and CFP; if a cluster has more than one available channel, the cluster header node selects one channel for use and identifies other channels as alternate channels;
2) The cluster header node judges the operation termination of system; if the operation system is terminated, the program should be ended; Otherwise, the following steps are performed;
3) The cluster header node periodically initializes the statistics of the channel conditions;
4) The cluster header node records the channel conditions measured by itself and cluster member nodes;
5) The cluster header node determines whether the time is in the PAHF channel measuring cycle; if it is not, the following steps are performed;
6) The cluster header node determines whether the packet loss rate of current utilized channel is greater than the predetermined threshold; if the packet loss rate of current utilized channel is not less than the predetermined threshold, the cluster header node reports the former channel's condition to the sink node;
7) The cluster header node determines whether there has an alternate channel; if so, the cluster head node switches to the alternate channel;
8) The cluster header node broadcasts the next channel used by cluster member nodes in Beacon period, CAP and CFP of next superframe cycle by utilizing the beacon frame;
9) The cluster header nodes and the cluster member nodes take advantage of the replaced channel to communicate with each other; and
Return to system to determine whether the operation of the system should be terminated.

If there has no alternate channel, the sink node reallocates channels for the related cluster head node. Thereafter, the cluster header node broadcasts the next channel used by cluster member nodes in the beacon period, CAP and CFP of next superframe cycle by utilizing the beacon frame.

If the packet loss rate of current utilized channel is less than the predetermined threshold, the program returns to system to determine whether the operation of the system should be terminated.

If the time is in the PAHF channel measuring cycle, return to the step: the cluster header node records the channel conditions measured by itself and cluster member nodes.

If the operation system is terminated, the program should be ended.

That the cluster header node broadcasts the next channel used by cluster member nodes in the beacon period, CAP and CFP of next superframe cycle by utilizing the beacon frame is described below: the beacon frame payload of IEEE 802.15.4 MAC is used to forecast the channel used in the latter superframe cycle. The beacon frame of this invention adopts the format of beacon frame in IEEE 802.15.4 MAC layer, and the payload has been extended. The extended beacon frame payload comprises cluster identifier, absolute timeslot number, and the channel used during the beacon period and the active period in the next superframe cycle.

For TAFH, this invention defines the following parameters: a channel switch threshold, the number of usable channels for intra-cluster communication, and an array to store all communication channels, which is allocated by the sink node to the cluster header node and the cluster member node.

The realization process of TAFH is as follows:
1) Initialize the channel allocation: the sink node pre-allocates n channels for each cluster member node, which are recorded in “an array to store all communication channels, which is allocated by the sink node to the cluster header node and the cluster member node”; one of these channels is denoted as “current available channel”, and others are denoted as “alternate channel”;
2) Judge the operation termination of system: if the operation system is terminated, the program should be ended; otherwise, the following steps are performed;
3) The statistics of channel conditions in the cluster header node and the cluster member nodes are set 0;
4) When the cluster header node and the cluster member node communicate with each other, both of them record the number of transmission failures while using the current available channel;
5) Determine whether the first communication on the current available channel is successful; if it is successful, the cluster header node and the cluster member node should synchronize the channel transmission failure count and set the channel transmission failure count to the smaller value;
6) Determine whether the statistical channel transmission failure count of either the cluster header node or the cluster member node equals to the value “channel switch threshold +2”; if not, the program goes to next step;
7) Determine whether the statistical channel transmission failure count of the sender equals to channel switch threshold; if the statistical channel transmission failure count of the transmitting node equals to channel switch threshold, the sender sends the channel switching notice that is carried by packets to the receiver;
8) Determine whether the channel switching notice is sent successfully; if the channel switching notice is sent successfully, the receiver orderly selects the next channel from the array to store all communication channels, which is allocated by the sink node to the cluster header node and the cluster member node, to replace the communication channel, and returns ACK; and
Return to system to determine whether the operation of the system should be terminated.

If the channel switching notice is not sent successfully, return to carry out the step of “when the cluster header node and the cluster member node communicate with each other, both of them record the number of transmission failures while using the current available channel”.

If the statistical channel transmission failure count of the transmitting node does not reach the channel switch threshold, return to carry out the step of “when the cluster header node and the cluster member node communicate with each other, both of them record the number of transmission failures while using the current available channel”.

If the statistical channel transmission failure count of either the cluster header node or the cluster member node equals to the value “channel switch threshold +2”, carry out the step of “the receiver orderly selects the next channel from the array to store all communication channels, which is allocated by the sink node to the cluster header node and the cluster member node”.

If the first communication on the current available channel is not successful, carry out the step of “determine whether the statistical channel transmission failure count of either the cluster header node or the cluster member node equals to the value “channel switch threshold +2”.

If the operation system is terminated, the program should be ended.

Advantages of the invention are summarized as follows:
1. The invention employs the a clustered wireless sensor network, which extend the network size, reduce the difficulty of maintenance and management, and improve the flexibility of the system;
2. The invention designs a superframe structure based on IEEE 802.15.4, which makes full use of the advantages of IEEE 802.15.4, improves the system compatibility, protects the existing investments, and meets the application requirements by extending the superframe structure;
3. The invention proposes a two-stage frequency hopping method, which guarantees the compatibility with IEEE 802.15.4 and the system reliability by using a variety of methods;
4. The invention designs the adaptive frequency hopping method, which switches channels according to the channel condition and avoids blindness of traditional frequency hopping method; and
5. The invention designs the beacon frame payload based on IEEE 802.15.4 to forecast the communication channel. On the one hand, there is no need to design a special frame for broadcasting channel allocation results during the channel switching process, and the design of the large scale network will be simple; on the other hand, the number of control frames is reduced and the network throughput improved.

### BRIEF DESCRIPTION OF THE DRAWINGS

FIG. 1 is a schematic diagram of a typical clustered wireless sensor network;

FIG. 2 is a schematic diagram of an extended superframe structure based on IEEE 802.15.4;

FIG. 3 is a flow chart of a period adaptive frequency hopping process for a clustered wireless sensor network;

FIG. 4 is a schematic diagram of a beacon frame format based on IEEE 802.15.4;

FIG. 5 is a schematic diagram of a beacon frame payload based on IEEE 802.15.4; and

FIG. 6 is a flow chart of a timeslot adaptive frequency hopping for a clustered wireless sensor network.

### DETAILED DESCRIPTION OF THE EMBODIMENTS

The method of this invention is described combing the attached diagrams in detail.

The method of this invention comprises the following steps.
Building a clustered wireless sensor network;
Defining a superframe structure based on IEEE 802.15.4 according to the above topology;
Extending a beacon frame payload based on a beacon frame format of the IEEE 802.15.4 Media Access Control (MAC) layer; and
Performing a two-stage adaptive frequency hopping mechanism on nodes based on the above superframe structure and the extended beacon frame of the IEEE 802.15.4 MAC layer.

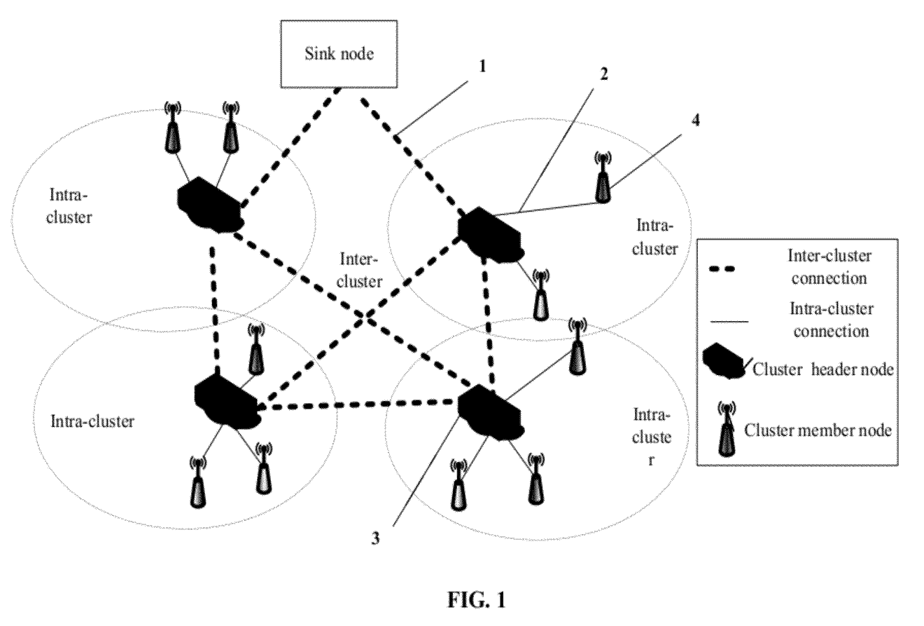

As shown in FIG. 1, this invention involves a clustered wireless sensor network, which comprises the following three kinds of nodes.

1) Sink Node

Sink node is the convergence center of data and provides interfaces for clustered WSNs to connect with other WSNs. The Sink node in this invention refers to a single node used as monitoring and control clearing house. Sink node can connect with wired networks, such as Ethernet. Sink node is used to manage node joining, network formation, and network performance monitoring.

2) Cluster Header Node

A cluster header node 3 is used to duplicate and forward data in a clustered WSN. The cluster header node can transmit or forward data to cluster member nodes, sink node, and other cluster header nodes in the network. The cluster header node can support any kinds of sensors and actuators.

3) Cluster Member Node

A cluster member node 4 that is set up in industrial fields and connect with sensors and actuators are used for transmitting process measurement and control data and accomplishing specific applications.

FIG. 1 is a diagram of a typical clustered WSN. In this clustered WSN, cluster header nodes and cluster member nodes constitute clusters. Therein, a cluster member node communicates with only one cluster header node, but not with each other; a cluster header node communicates with the sink node and other cluster header nodes.

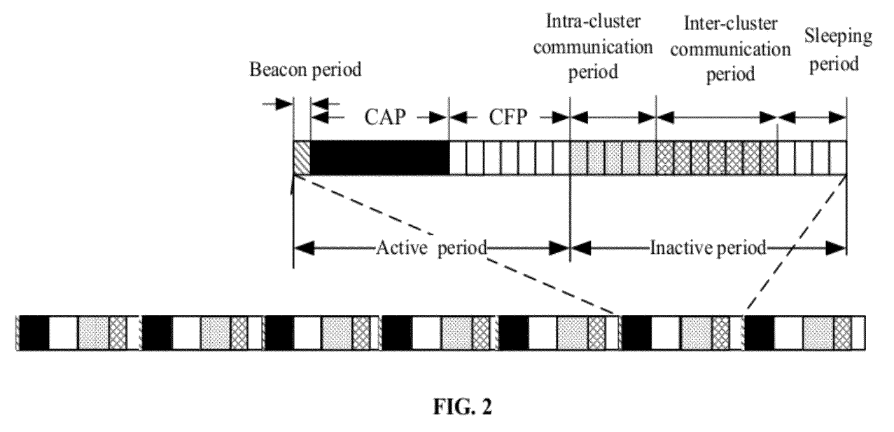

Among the present wireless communication standards, IEEE 802.15.4 has many features, such as low energy consumption, low cost, easy use, and high flexibility, which make it a most promising under layer communication protocol for WSNs. Therefore, the superframe structure in this invention is extended based on IEEE 802.15.4, as shown in FIG. 2, which is described as follows.

1) Beacon frame period is used for timeslot synchronization and superframe information publishing;

2) Contention Access Period (CAP) is used for node adding and intra-cluster management, which realizes medium access control by the timeslot Carrier Sense Multiple Access with Collision Avoidance (CSMA/CA) algorithm;

3) Contention-Free Period (CFP) is used for emergency communications and communications among mobile cluster member nodes and cluster header nodes, which is distributed by cluster header nodes themselves. In contention-free access period, communication is finished by using the Time Division Multiple Access (TDMA) mechanism;

4) The inactive period comprises intra-cluster communication period, inter-cluster communication period, and sleeping period, which is used for intra-cluster communication 2, inter-cluster communication 1, and sleeping. These periods are uniformly allocated by the sink node. The intra-cluster communication period is the extension of the CFP and used for intra-cluster communication; the inter-cluster communication period is used for inter-cluster communication and management. The intra-cluster communication period and the inter-cluster communication period use TDMA to finish communication.

The intra-cluster communication means communication between the cluster header node and the cluster member node; the inter-cluster means communication among the cluster header nodes and communication between the cluster header node and the sink node.

For a clustered WSN, this invention designs a two-stage adaptive frequency hopping method: the first stage is the Period Adaptive Frequency Hopping (PAFH), and the second stage is the Timeslot Adaptive Frequency Hopping (TAFH).

1) Period adaptive frequency hopping (PAFH): in the superframe of a clustered WSN, the beacon period, contention access period, and contention-free access period use the same channel in the same superframe cycle, and change the channels according to the channel conditions in different superframe cycles. When the channel condition is bad, the communication channel is changed by the nodes. The channel condition is evaluated by Packet Loss Rate (PLR) and retransmission times.

2) Timeslot adaptive frequency hopping (TAFH): in the superframe of a clustered WSN, timeslots of intra-cluster communication period change the communication channel according to the channel condition; when the channel condition is bad; the node changes the communication channel condition. The channel condition is evaluated by PLR and retransmission times.

For PAFH and TAFH, the channel condition should be measured. The channel measurement is used for offering the channel condition to the sink node and the cluster header node, helping the sink node and the cluster header node to allocate communication channel. A cluster member node (or a cluster header node) can measure one or more channel condition, and report the statistical information to the cluster header node (or the sink node). The cluster member node transmits the measurement result collected from cluster member nodes to cluster header nodes, and a cluster header node transmits the channel condition collected from itself and from the cluster member nodes to the sink node.

In the process of channel measurement, each node records the conditions of all the channels that are used for communication with the node in the measurement period; the recorded performance information comprises packet loss rate and retransmission times; The packet loss rate are determined by the number of the acknowledgment frames (ACK) and the number of transmitted packets.

The realization of PAFH and TAFH is explained in details as follows.

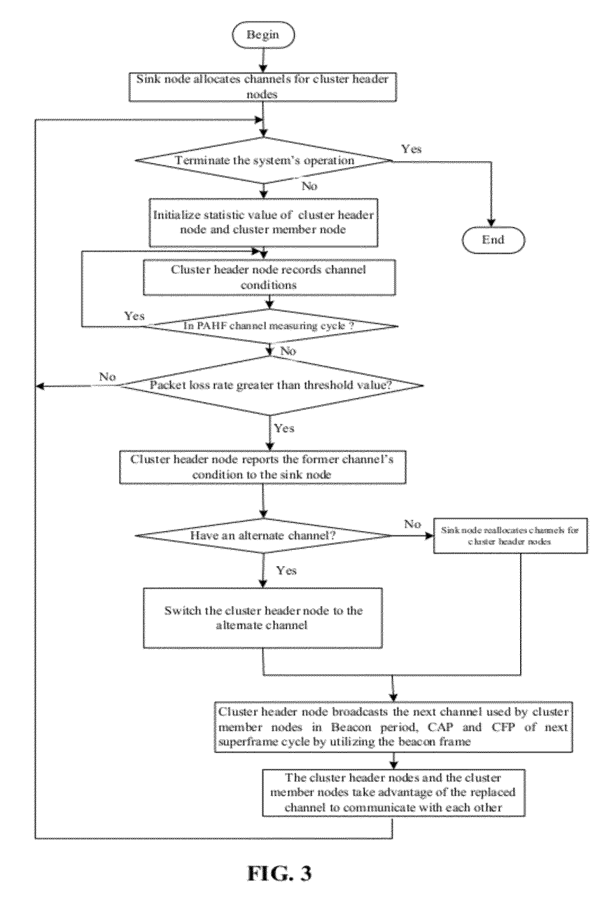

As shown in FIG. 3, the realization process of PAFH is as follows.

1) At first, the sink node allocates channels for each cluster header node's beacon period, CAP and CFP; if a cluster has more than one available channel, the cluster header node selects one channel for use and identifies other channels as alternate channels;

2) The cluster header node judges the operation termination of system; if the operation system is terminated, the program should be ended; otherwise, the following steps are performed;

3) The cluster header node periodically initializes the statistics of the channel conditions;

4) The cluster header node records the channel conditions measured by itself and cluster member nodes;

5) The cluster header node determines whether the time is in the PAHF channel measuring cycle; if it is, the program returns to Step 4; otherwise, the following steps are performed;

6) The cluster header node determines whether the packet loss rate of current utilized channel is greater than the predetermined threshold; if the packet loss rate of current utilized channel is not less than the predetermined threshold, the cluster header node reports the former channel's condition to the sink node; otherwise, the program returns to Step 2;

7) The cluster header node determines whether there has an alternate channel; If so, the cluster head node switches to the alternate channel; if the measured quality of all channels in a cluster is lower than the threshold value, and there has no an alternate channel, the sink node reallocates channels for the related cluster head node;

8) The cluster header node broadcasts the next channel used by cluster member nodes in Beacon period, CAP and CFP of next superframe cycle by utilizing the beacon frame.

9) The cluster header nodes and the cluster member nodes take advantage of the replaced channel to communicate with each other.

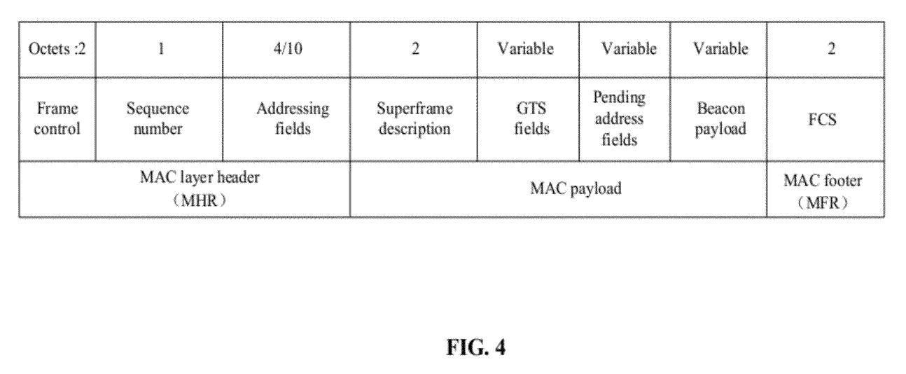

For PAFH, the beacon frame in the former superframe cycle is used to forecast the channel used in latter superframe cycle. The format of the beacon frame is shown in FIG. 4. The beacon frame of this invention adopts the format of beacon frame in IEEE 802.15.4 MAC layer. The detailed parameters refer to IEEE 802.15.4-2006 standard.

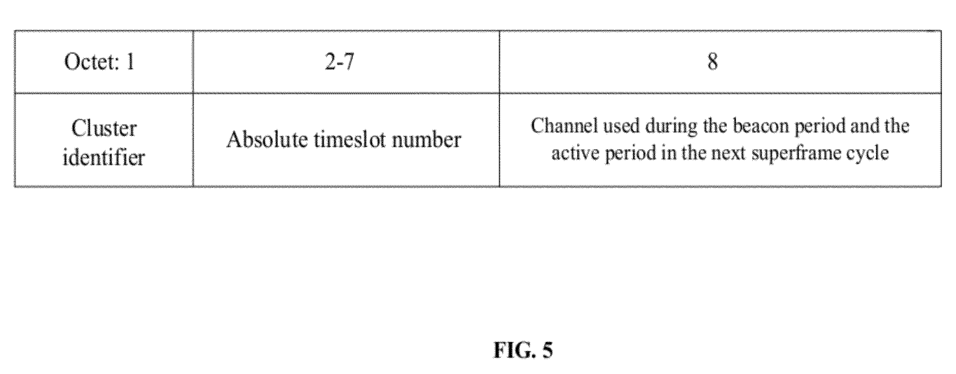

The invention makes use of the beacon frame payload of IEEE 802.15.4 MAC to forecast the channel used in the latter superframe cycle. As shown in FIG. 5, the beacon frame payload specifically comprises the following parameters: cluster identifier, absolute timeslot number, and the channel used during the beacon period and the active period in the next superframe cycle.

For TAFH, this invention defines the following parameters, which is shown in Table 1.

TABLE 1
Parameter definitions of TAFH

| | Default | |
|---|---|---|
| Parameter name | Value | Description |
| ChannelThreshold | 1 | The channel switch threshold in adaptive |
| | | frequency hopping, denoted as |
| | | retransmission count during one channel |
| | | measurement cycle. |
| IntraChannelNum | 1 | The number of usable channels for intra- |
| | | cluster communication |
| IntraChanel[ ] | 0 | An array to store all communication |
| | | channels, which is allocated by the sink node |
| | | to the cluster header node and the cluster |
| | | member node. The size of the array is |
| | | IntraChannelNum. |

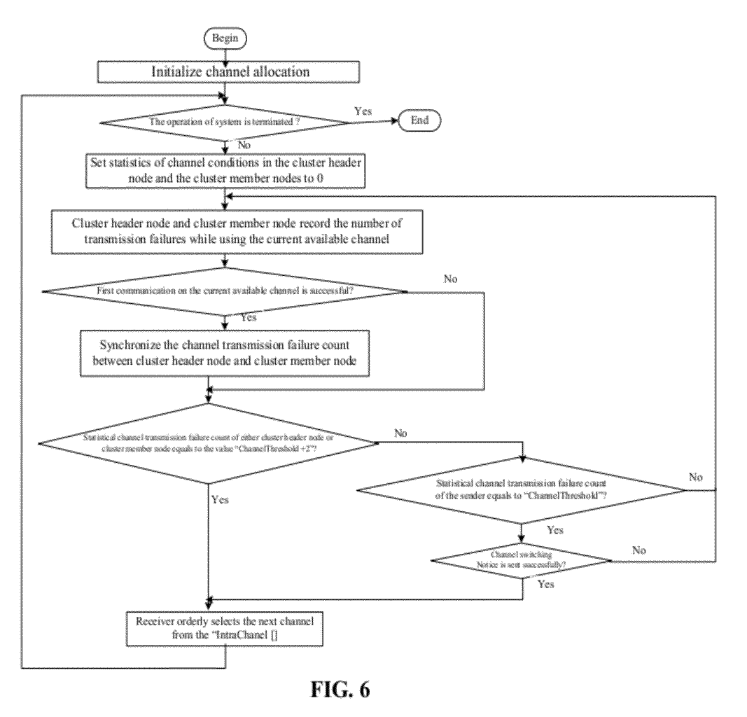

As shown in FIG. 6, the realization process of TAFH is as follows.

1) Initialize the channel allocation: the sink node pre-allocates n channels for each cluster member node, which are recorded in “IntraChanel[ ]”; one of these channels is denoted as “current available channel”, and others are denoted as “alternate channel”;

2) Judge the operation termination of system: if the operation system is terminated, the program should be ended; otherwise, the following steps are performed;

3) The statistics of channel conditions in the cluster header node and the cluster member nodes are set 0;

4) When the cluster header node and the cluster member node communicate with each other, both of them record the number of transmission failures while using the current available channel;

5) Determine whether the first communication on the current available channel is successful; if it is successful, the cluster header node and the cluster member node should synchronize the channel transmission failure count and set the channel transmission failure count to the smaller value; otherwise, the program goes to Step 6;

6) Determine whether the statistical channel transmission failure count of either the cluster header node or the cluster member node equals to the value “ChannelThreshold +2”; if the statistical channel transmission failure count of either the cluster header node or the cluster member node equals to the value “ChannelThreshold +2”, the program goes to Step 7; otherwise, the cluster header node and the cluster member node select the next channel from the “IntraChanel [ ]” for next communication;

7) Determine whether the statistical channel transmission failure count of the sender equals to “ChannelThreshold”; if the statistical channel transmission failure count of the transmitting node equals to “ChannelThreshold”, the sender sends the channel switching notice that is carried by packets to the receiver; otherwise, the program returns to step 4;

8) Determine whether the channel switching notice is sent successfully; If the channel switching notice is sent successfully, the receiver orderly selects the next channel from the “IntraChanel [ ] to replace the communication channel, and returns ACK; if the channel switching notice is not sent successfully, that is to say, either the receiver does not receive the notice to switch the channel, or the sender does not receive ACK, the program returns to step 4.

The invention claimed is:

1. A method of two-stage adaptive frequency hopping for a clustered wireless sensor network (WSN), comprising the steps of:
a) building a clustered wireless sensor network;
b) defining a superframe structure based on IEEE 802.15.4 according to a topology of the clustered wireless sensor network;
c) extending a beacon frame payload based on a beacon frame format of an IEEE 802.15.4 Media Access Control (MAC) layer; and
d) performing a two-stage adaptive frequency hopping mechanism on nodes based on the above superframe structure and the extended beacon frame of the IEEE 802.15.4 MAC layer.

2. The method of claim 1, wherein
the clustered wireless sensor network comprises the following three kinds of nodes: a sink node, a cluster header node, and a cluster member node;
the sink node is a data convergence center, which provides interfaces for clustered WSNs to connect with other WSNs and is used to manage node joining, network formation, and network performance monitoring;
the cluster header node is used to duplicate and forward data in the clustered WSN, to transmit or forward data to cluster member nodes, sink node, and other cluster header nodes in the network, and to support any kinds of sensors and actuators;
the cluster member node that is set up in industrial fields and connects with sensors and actuators is used for transmitting measurement and control data;
the cluster header node and the cluster member node constitute clusters;
the cluster member node communicates with only one cluster header node, but not with each other; and
the cluster header node communicates with the sink node and other cluster header nodes.

3. The method of claim 1, wherein
the superframe structure based on IEEE 802.15.4 comprises a beacon frame period, a contention access period (CAP), a contention-free period (CFP), an intra-cluster communication period, an inter-cluster communication period, and a sleeping period;
the beacon frame period is used for timeslot synchronization and superframe information publishing;
the contention access period is used for node adding and intra-cluster management, which realizes medium access control by the timeslot Carrier Sense Multiple Access with Collision Avoidance (CSMA/CA) algorithm;
the contention-free period is used for emergency communications and communications among mobile cluster member nodes and cluster header nodes, which is distributed by cluster header nodes themselves; in contention-free access period, communication is finished by using the Time Division Multiple Access (TDMA) mechanism;
the intra-cluster communication period is the extension of the CFP and used for intra-cluster communication;
the inter-cluster communication period is used for inter-cluster communication and management; and
both the intra-cluster communication period and the inter-cluster communication period use TDMA to finish communication.

4. The method of claim 3, wherein
the intra-cluster communication means communication between the cluster header node and the cluster member node; and
the inter-cluster means communication among the cluster header nodes and communication between the cluster header node and the sink node.

5. The method of claim 1, wherein
the two-stage adaptive frequency hopping comprises a period adaptive frequency hopping (PAFH) and a timeslot adaptive frequency hopping (TAFH);
PAFH: in the superframe of a clustered WSN, the beacon period, contention access period, and contention-free access period use the same channel in the same superframe cycle, and change the channels according to the channel conditions in different superframe cycles; when the channel condition is bad, the communication channel is changed by the nodes; the channel condition is evaluated by Packet Loss Rate (PLR) and retransmission times; and
TAFH: in the superframe of a clustered WSN, timeslots of intra-cluster communication period change the communication channel according to the channel condition; when the channel condition is bad; the node changes the communication channel condition; the channel condition is evaluated by PLR and retransmission times.

6. The method of claim 5, wherein
before the two-stage adaptive frequency hopping, the channel condition is measured;
the channel measurement is used for offering the channel condition to the sink node and the cluster header node, helping the sink node and the cluster header node to allocate communication channel;
a cluster member node or a cluster header node can measure one or more channel condition, and report the statistical information to the cluster header node or the sink node; and
the cluster member node transmits the measurement result collected from cluster member nodes to cluster header nodes, and a cluster header node transmits the channel condition collected from itself and from the cluster member nodes to the sink node.

7. The method of claim 6, wherein
in the process of channel measurement, each node records the conditions of all the channels that are used for communication with the node in the measurement period;
the recorded performance information comprises packet loss rate and retransmission times; and
the packet loss rate is determined by the number of the acknowledgment frames (ACK) and the number of transmitted packets.

8. The method of claim 5, wherein the realization process of PAFH is as follows:
a) first, the sink node allocates channels for each cluster header node's beacon period, CAP and CFP; if a cluster has more than one available channel, the cluster header node selects one channel for use and identifies other channels as alternate channels;
b) the cluster header node judges the operation termination of system; if the operation system is terminated, the program should be ended; otherwise, the following steps are performed;
c) the cluster header node periodically initializes the statistics of the channel conditions;
d) the cluster header node records the channel conditions measured by itself and cluster member nodes;
e) the cluster header node determines whether the time is in the PAHF channel measuring cycle; if it is not, the following steps are performed;
f) the cluster header node determines whether the packet loss rate of current utilized channel is greater than the predetermined threshold; if the packet loss rate of current utilized channel is not less than the predetermined threshold, the cluster header node reports the former channel's condition to the sink node;
g) the cluster header node determines whether there has an alternate channel; if so, the cluster head node switches to the alternate channel;
h) the cluster header node broadcasts the next channel used by cluster member nodes in the beacon period, CAP and CFP of next superframe cycle by utilizing the beacon frame;
i) the cluster header nodes and the cluster member nodes take advantage of the replaced channel to communicate with each other; and
return to system to determine whether the operation of the system should be terminated.

9. The method of claim 8, wherein
if there has no alternate channel, the sink node reallocates channels for the related cluster head node; and
the cluster header node broadcasts the next channel used by cluster member nodes in the beacon period, CAP and CFP of next superframe cycle by utilizing the beacon frame.

10. The method of claim 8, wherein if the packet loss rate of current utilized channel is less than the predetermined threshold, the program returns to system to determine whether the operation of the system should be terminated.

11. The method of claim 8, wherein if the time is in the PAHF channel measuring cycle, return to the step: the cluster header node records the channel conditions measured by itself and cluster member nodes.

12. The method of claim 8, wherein if the operation system is terminated, the program should be ended.

13. The method of claim 8, wherein that the cluster header node broadcasts the next channel used by cluster member nodes in the beacon period, CAP and CFP of next superframe cycle by utilizing the beacon frame is described below:
the beacon frame payload of IEEE 802.15.4 MAC is used to forecast the channel used in the latter superframe cycle;
the beacon frame of this invention adopts the format of beacon frame in IEEE 802.15.4 MAC layer, and the payload has been extended; and
the extended beacon frame payload comprises cluster identifier, absolute timeslot number, and the channel used during the beacon period and the active period in the next superframe cycle.

14. The method of claim 5, wherein the TAFH comprises the following parameters:
a channel switch threshold, the number of usable channels for intra-cluster communication, and an array to store all communication channels, which is allocated by the sink node to the cluster header node and the cluster member node.

15. The method of claim 5, wherein the realization process of TAFH is as follows:
a) initialize the channel allocation: the sink node pre-allocates n channels for each cluster member node, which are recorded in an array to store all communication channels, which is allocated by the sink node to the cluster header node and the cluster member node; one of these channels is denoted as current available channel, and others are denoted as alternate channel;
b) judge the operation termination of system: if the operation system is terminated, the program should be ended; otherwise, the following steps are performed;
c) the statistics of channel conditions in the cluster header node and the cluster member nodes are set 0;
d) when the cluster header node and the cluster member node communicate with each other, both of them record the number of transmission failures while using the current available channel;
e) determine whether the first communication on the current available channel is successful; if it is successful, the cluster header node and the cluster member node should synchronize the channel transmission failure count and set the channel transmission failure count to the smaller value;
f) determine whether the statistical channel transmission failure count of either the cluster header node or the cluster member node equals to the value “channel switch threshold +2”; if not, the program goes to next step;
g) determine whether the statistical channel transmission failure count of the sender equals to channel switch threshold; if the statistical channel transmission failure count of the transmitting node equals to channel switch threshold, the sender sends the channel switching notice that is carried by packets to the receiver; and
h) determine whether the channel switching notice is sent successfully;
if the channel switching notice is sent successfully, the receiver orderly selects the next channel from the array to store all communication channels, which is allocated by the sink node to the cluster header node and the cluster member node, to replace the communication channel, and returns ACK; and return to system to determine whether the operation of the system should be terminated.

16. The method of claim 15, wherein if the channel switching notice is not sent successfully, return to carry out the step of: when the cluster header node and the cluster member node communicate with each other, both of them record the number of transmission failures while using the current available channel.

17. The method of claim 15, wherein if the statistical channel transmission failure count of the transmitting node does not reach the channel switch threshold, return to carry out the step of: when the cluster header node and the cluster member node communicate with each other, both of them record the number of transmission failures while using the current available channel.

18. The method of claim 15, wherein if the statistical channel transmission failure count of either the cluster header node or the cluster member node equals to the value “channel switch threshold +2”, carry out the step of “the receiver orderly selects the next channel from the array to store all communication channels, which is allocated by the sink node to the cluster header node and the cluster member node”.

19. The method of claim 15, wherein if the first communication on the current available channel is not successful, carry out the step of determine whether the statistical channel transmission failure count of either the cluster header node or the cluster member node equals to the value channel switch threshold +2.

20. The method of claim 15, wherein if the operation system is terminated, the program should be ended.
